(19) United States
(12) Patent Application Publication
(10) Pub. No.: US 2007/0227311 A1
(43) Pub. Date: Oct. 4, 2007

(54) Socket for a wrench

(76) Inventor: Shyh-Ming Wang, Taichung Hsien (TW)

Correspondence Address: Shyh-Ming, Wang, No.37-2, Ching-Dau 1st Street, Taichung, 404, TW

(21) Appl. No.: 11/396,842

(22) Filed: Apr. 4, 2006

(51) Int. Cl. B25B 13/02

(52) U.S. Cl. 81/125

(57) ABSTRACT

This invention comprises a main body that has a proximal end and a distal end; the central axis of the proximal end extends to the distal end. The main body has recess at inside on the proximal end with punctures on the recessed periphery; each puncture has a moving part mounted on to, the moving part has its primary end and secondary end. A sleeve is in slide-fitting onto the outside of the main body, which has its central axis parallel with the central axis of the main body; inner wall of the sleeve has a plurality of push fronts, each push front contacts with the primary end of the moving part, each push front surface rises gradually from one end to the other. When the sleeve is rotating on the main body, the gradual rising push fronts are pushing the moving parts toward or away from the central axis to match with varieties of scales of work pieces.

### FIELD OF THE INVENTION

This invention is about a kind of wrench sleeve, especially the one that can match with varieties of scales of work pieces.

### BACKGROUND OF THE INVENTION

As what had been acknowledged, the current patent of common size and structure adjustable wrench sleeves such as U.S. Pat. No. 6,374,710 is using the retractable effect of a plurality of pillar posts mounted inside the sleeve to match with varieties of specifications of work pieces. The structure is more than complicated, quite a number of elements (such as sleeve 1, pillar post 3, retaining rod 4 and retraction spring 5) are required and necessary to be accommodated into sleeve 1, which needs higher cost in manufacturing and is presumed inconvenient to use because aligning is required when using it.

U.S. Pat. Nos. 1,471,451 and 3,698,267 are also about couplings of varieties of specifications, which are similar concept in structure design to the above-mentioned U.S. Pat. No. 6,374,710 and bear the same shortages in use.

### SUMMARY OF THE INVENTION

This invention comprises a main body that has a proximal end and a distal end; the central axis of the proximal end extends to the distal end. The main body has recess at inside on the proximal end with punctures on the recessed periphery; each puncture has a moving part mounted on to, the moving part has its primary end and secondary end. A sleeve is in slide-fitting onto the outside of the main body, which has its central axis parallel with the central axis of the main body; inner wall of the sleeve has a plurality of push fronts, each push front contacts with the primary end of the moving part, each push front surface rises gradually from one end to the other. When the sleeve is rotating on the main body, the gradual rising push fronts are pushing the moving parts toward or away from the central axis to match with varieties of scales of work pieces.

### BRIEF DESCRIPTION OF THE DRAWINGS

FIG. 1 is an exploded perspective of the first embodiment of the present invention;

FIG. 2 is an assembly appearance of FIG. 1;

FIG. 3 is a side view of FIG. 2;

FIG. 4 is the A-A cross-section view of FIG. 3;

FIG. 4-A is the motion diagram of FIG. 4;

FIG. 5 is the B-B cross-section view of FIG. 3;

FIG. 6 is an exploded perspective of the second embodiment of the present invention;

FIG. 7 is an exploded perspective of the third embodiment of the present invention;

FIG. 8 is an assembly appearance of FIG. 7;

FIG. 9 is a cross-section view of FIG. 8;

FIG. 10 is an exploded perspective of the fourth embodiment of the present invention;

FIG. 11 is an assembly front view of FIG. 10;

FIG. 12 is the C-C cross-section view of FIG. 11;

FIG. 13 is an exploded perspective of the fifth embodiment of the present invention;

FIG. 14-A is an assembly front view of FIG. 13;

FIG. 14-B is the C-C cross-section view of FIG. 14-A;

FIG. 15 is an exploded perspective of the sixth embodiment of the present invention;

FIG. 16 is an assembly front view of FIG. 15;

FIG. 17 is the C-C cross-section view of FIG. 16;

FIG. 18 is an exploded perspective of the seventh embodiment of the present invention;

FIG. 19 is an exploded perspective of the eighth embodiment of the present invention;

FIG. 20 is the cross-section view of FIG. 19;

FIG. 21 is an exploded perspective of the ninth embodiment of the present invention;

FIG. 22 is an exploded perspective of the tenth embodiment of the present invention;

FIG. 23 is a partial assembly appearance of FIG. 22;

FIG. 24 is an assembly appearance of FIG. 22;

FIG. 25 is a side view of FIG. 24;

FIG. 26 is the motion diagram of FIG. 25;

FIG. 27 is a 3-dimension view of FIG. 26;

FIG. 28 is an exploded perspective of the eleventh embodiment of the present invention;

FIG. 29 is a partial assembly appearance of FIG. 28;

FIG. 30 is an exploded perspective of the twelfth embodiment of the present invention;

FIG. 31 is an assembly 3-dimension section view of FIG. 30;

FIG. 32 is the motion diagram of FIG. 31;

FIG. 33 is an exploded perspective of the thirteenth embodiment of the present invention;

FIG. 34 is a partial assembly 3-dimension section view of FIG. 33; and

FIG. 35 is the motion diagram of FIG. 34;

### DETAILED DESCRIPTION OF THE PREFERRED EMBODIMENT

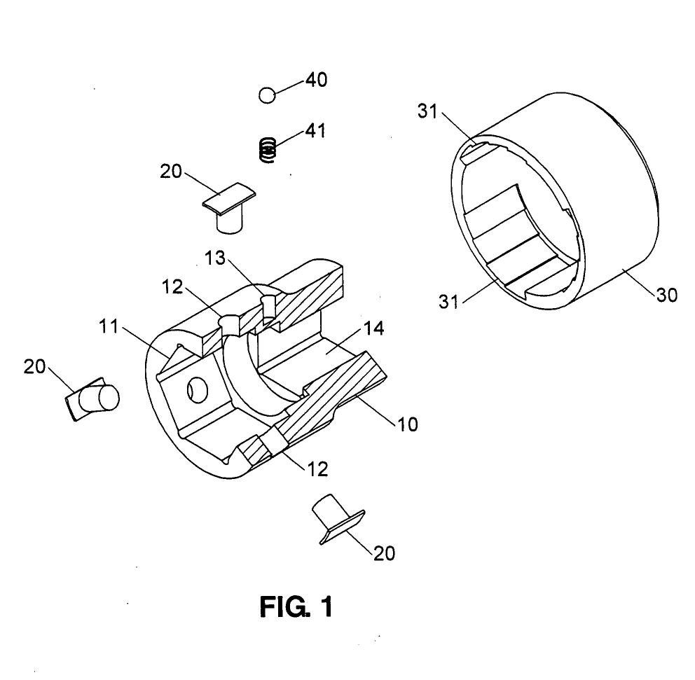

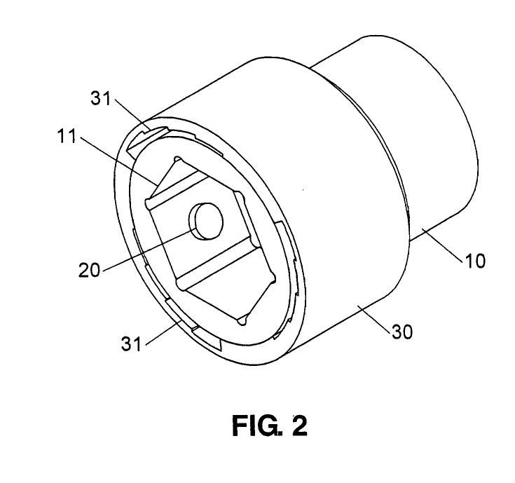

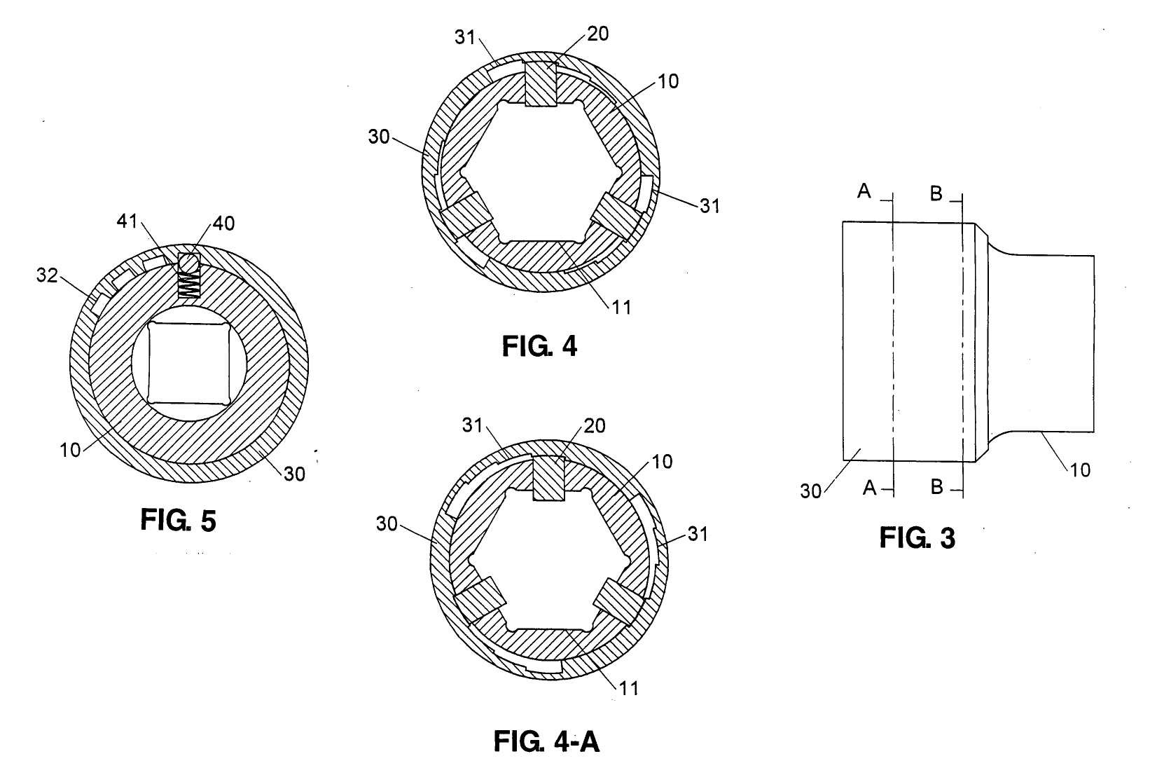

As shown on FIGS. 1 to 5, this invention comprises a main body 10 that has a proximal end and a distal end; the central axis of the proximal end extends to the distal end. The main body 10 has recess 11 on the proximal end with plurality punctures 12 on the recessed periphery; each puncture 12 has a moving part 20 mounted on to, the moving part 20 has its primary end and secondary end. A sleeve 30 is in slide-fitting onto the outside of the main body 10, which has its central axis parallel with the central axis of the main body 10; inner wall of the sleeve 30 has a plurality of push fronts 31, each push front 31 contacts with the primary end of the moving part 20, each push front 31 surface rises gradually from one end to the other. When the sleeve 30 is rotating with respect to the main body 10, the gradual rising push fronts 31 are pushing the moving parts 20 toward the central axis (comparing with FIGS. 4 and 4-A), and then a work piece with smaller scale can be fitted into.

Referring to FIG. 1 and FIG. 5, in the first embodiment, the distal end of the main body 10 has a square cavity 14 for the driving spanner to connect to. And a ball groove 13 is implemented on the periphery of the main body 10 with a spring 41 and a sphere 40 installed. There are plurality cavities 32 on the inner wall of the sleeve 30, which are implemented to have the sphere 40 to be positioned in to. The push front 31 on the inner wall of the sleeve 30 is shaped as steps. The number of the puncture 12 on the main body 10 can be two, each puncture 12 has a moving part 20 mounted therethrough, and the number of the push front 31 is two; the number of the puncture 12 on the main body 10 can also be three, each puncture 12 has a moving part 20 mounted therethrough, then the number of the push front 31 is three.

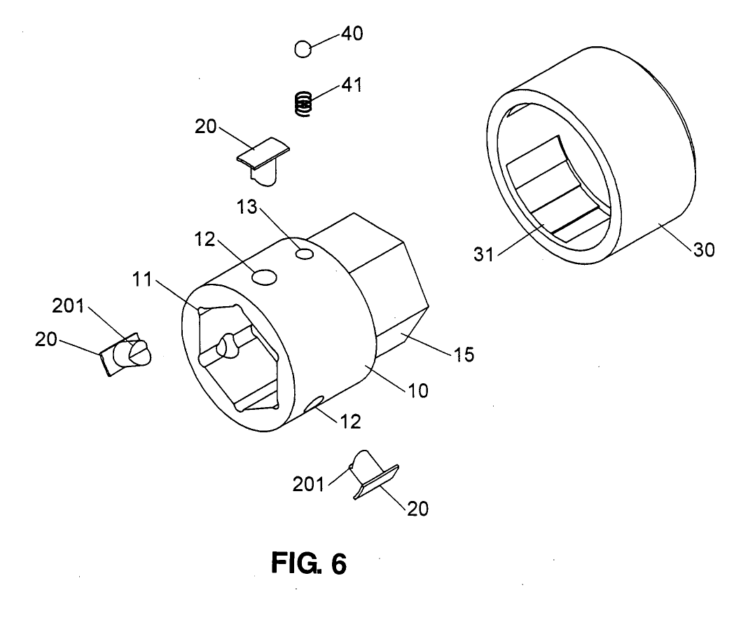

As shown on FIG. 6, in the second embodiment of this invention, the outline of the recess 11 is in the shape of polygon in the view of cross-section which is vertical with respect to the central axis, and punctures 12 are located on corners of the polygonal recess 11; a V shape groove 201 is implemented on the secondary end of the moving part 20, which coincides with the angle of the polygon corners of the recess 11.

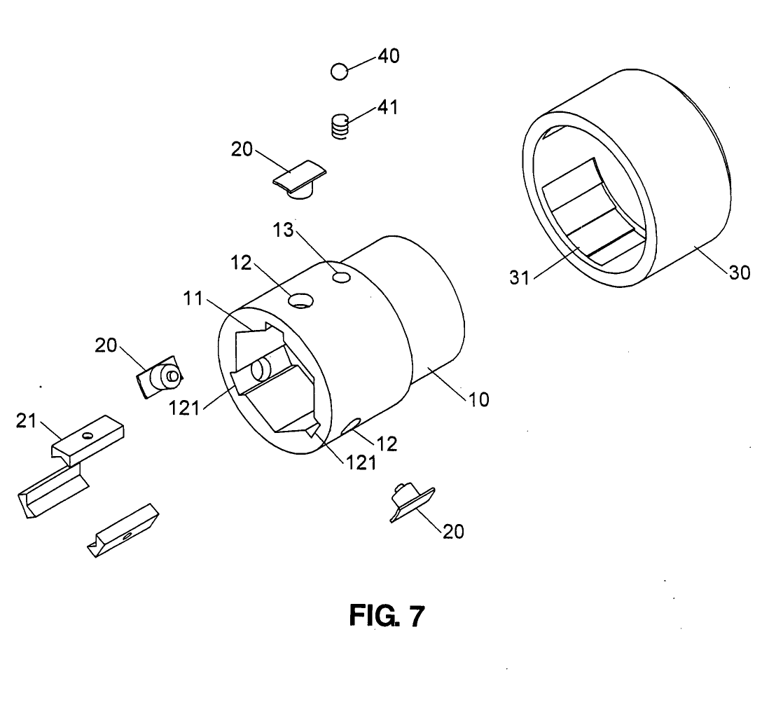

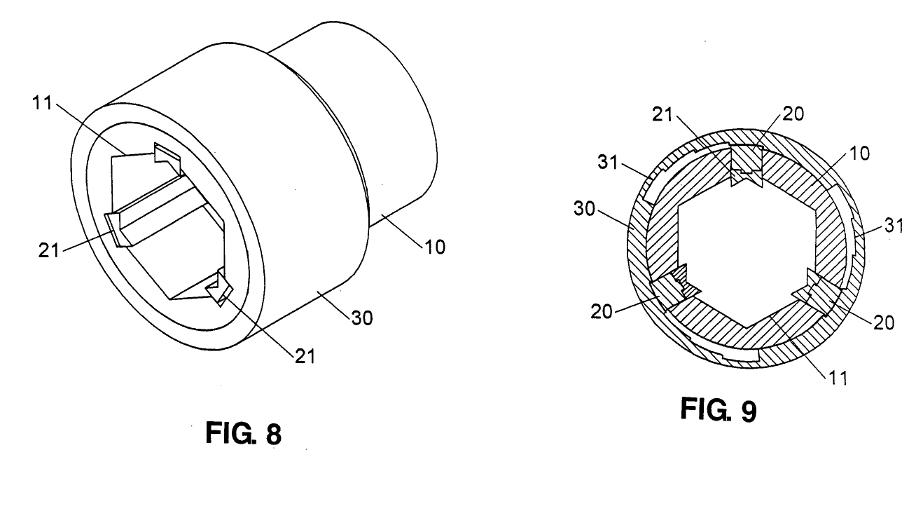

As shown on FIGS. 7 to 9, in the third embodiment of this invention, a block 21 is connected to the secondary end of the moving part 20, in which screw can be used for the connection.

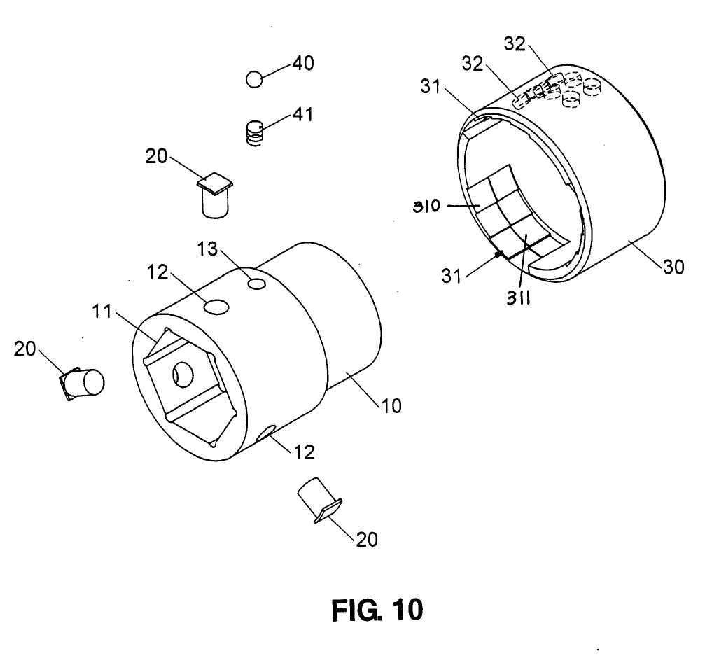

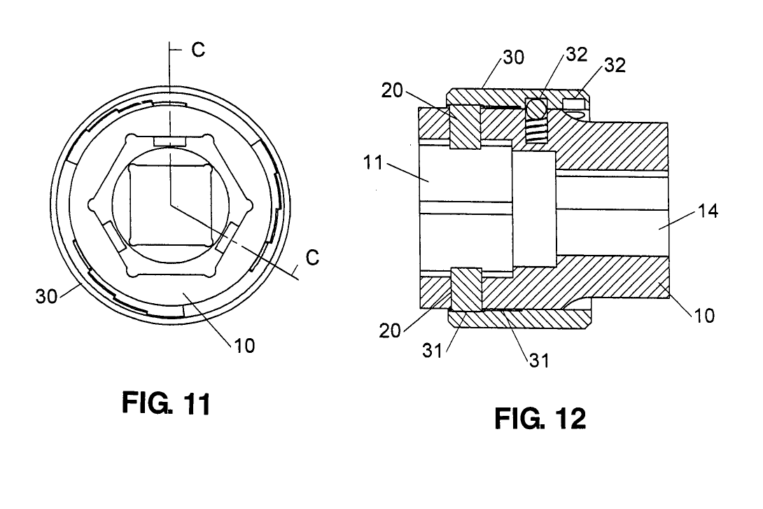

As shown on FIGS. 10 to 12, in the fourth embodiment of this invention, the push front 31 on the inner wall of the sleeve 30 is divided to array of push fronts 310 and 311 in different heights. Each of the push fronts 310 and 311 pushes the moving part 20 to match with different specifications of the work pieces, i.e. the push front 310 is used to match with the work piece in SI (International System of Units) standard; the push front 311 is used to match with the work piece in Imperial units. The cavities 32 on the inner wall of the sleeve 30 are also implemented in array to match the design. Furthermore in the embodiment, the push front 31 on the inner wall of the sleeve 30 can be designed to rise gradually from one lateral side to the other lateral side, then the push front 31 can move the moving part 20 when the sleeve 30 is either rotating or moving relatively to the main body 10.

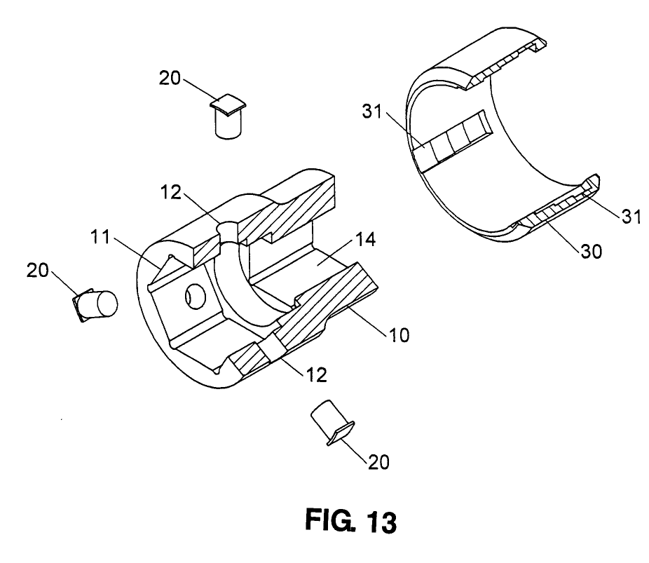

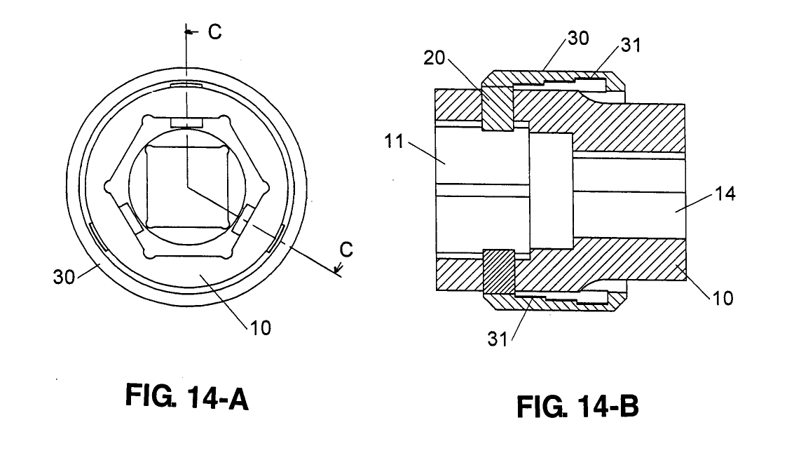

As shown on FIGS. 13, 14-A and 14-B, in the fifth embodiment of this invention, the push front 31 on the inner wall of the sleeve 30 is designed to rise gradually in the direction same as the central axis of the sleeve 30, then the push front 31 can move the moving part 20 when the sleeve 30 is moving linearly to the main body 10.

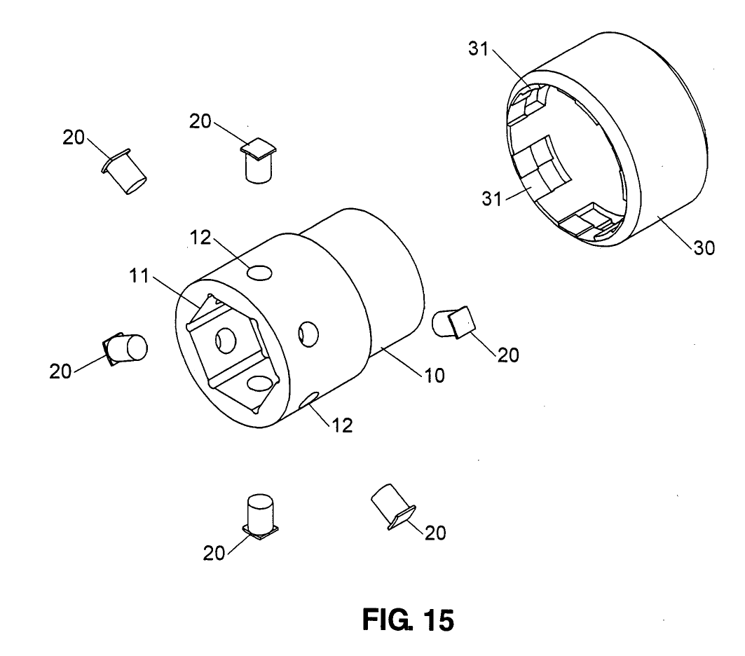

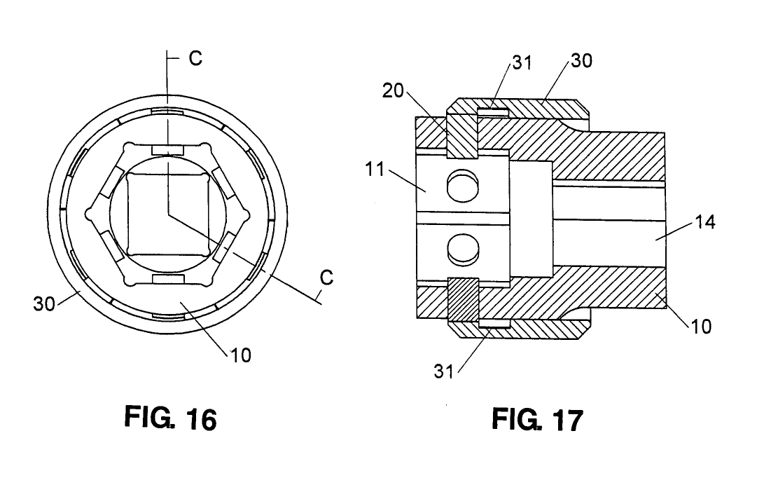

As shown on FIGS. 15 to 17, in the sixth embodiment of this invention, the number of the puncture 12 on the main body 10 is six, each puncture 12 has a moving part 20 mounted therethrough, and the number of the push front 31 on the inner wall of the sleeve 30 is six. The push front 31 on the inner wall of the sleeve 30 rises gradually from one lateral side to the other lateral side.

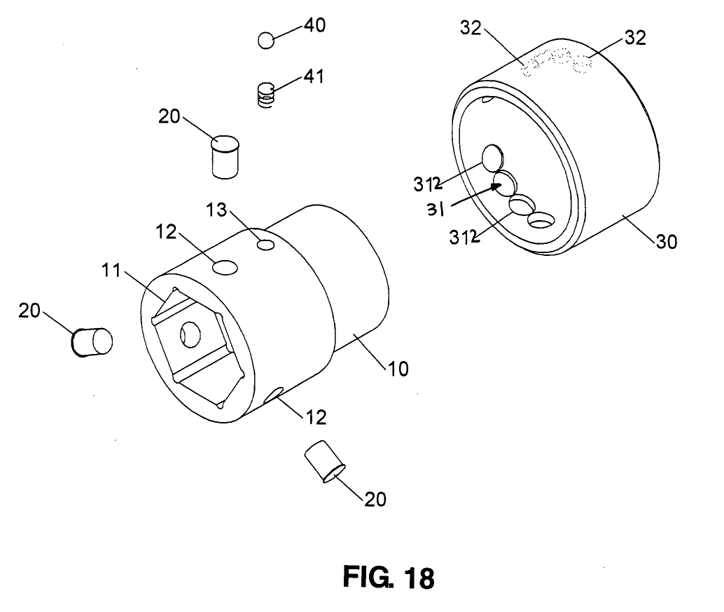

As shown on FIG. 18, in the seventh embodiment of this invention, several round grooves 312 in varieties of depth provided to construct the push front 31.

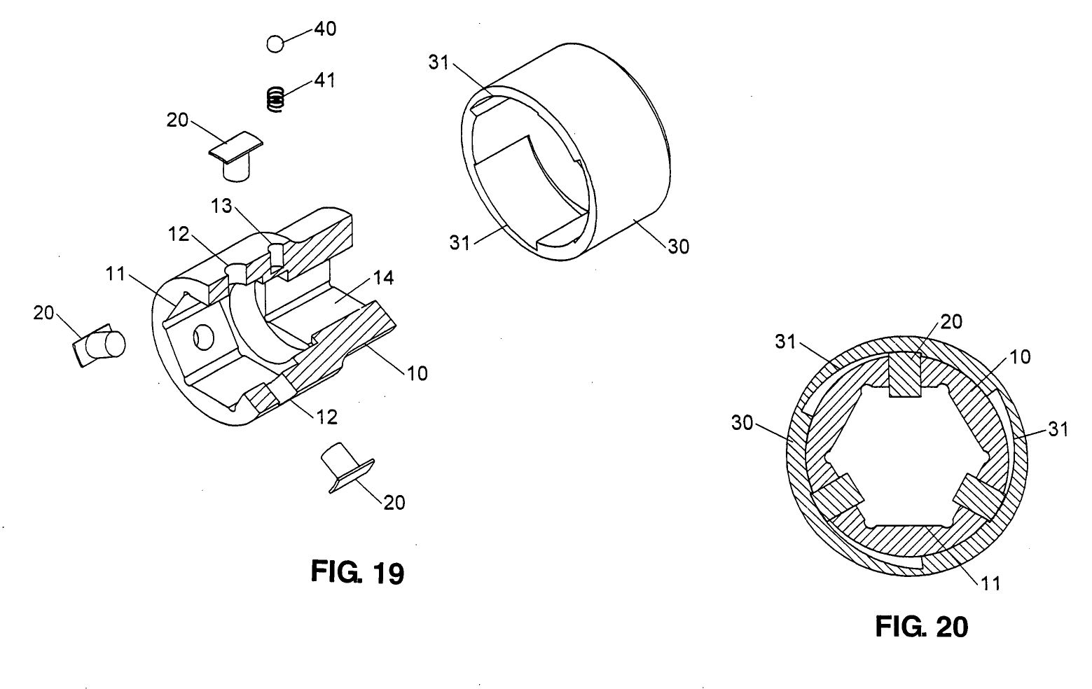

As shown on FIGS. 19 and 20, in the eighth embodiment of this invention, the push front 31 is rising smoothly, instead of in shape of steps, from one side to the other.

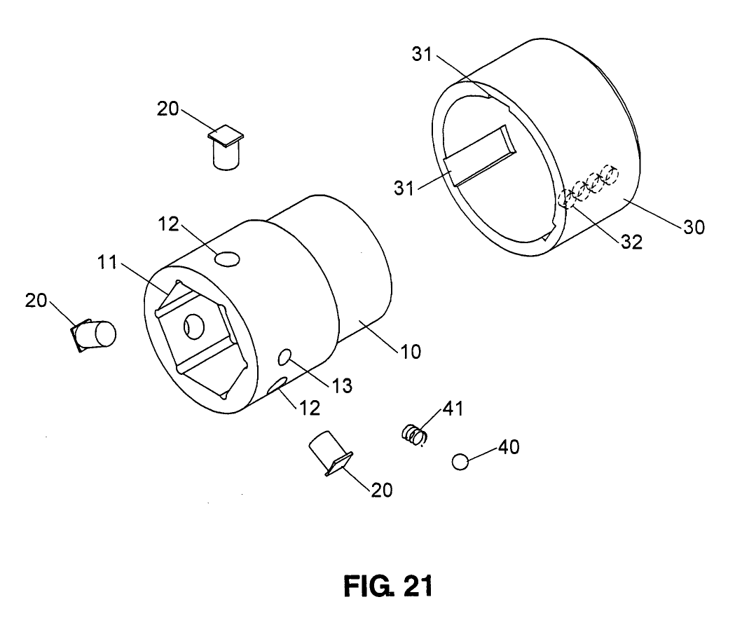

As shown on FIG. 21, in the ninth embodiment of this invention, the push front 31 is formed by a groove on the inner wall of the sleeve 30.

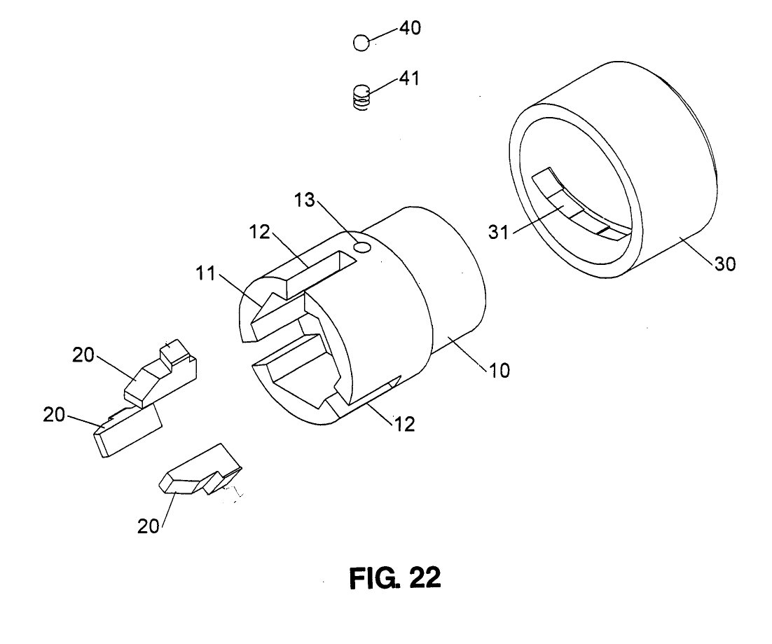

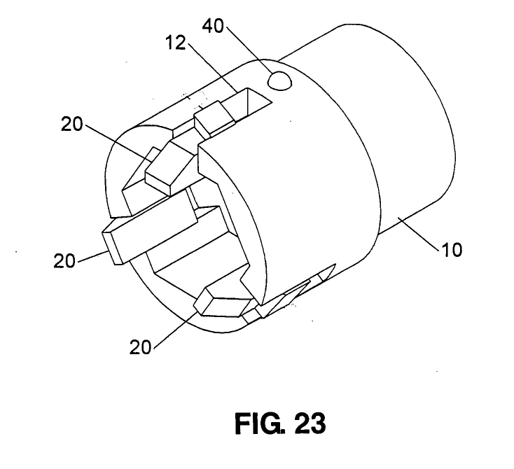

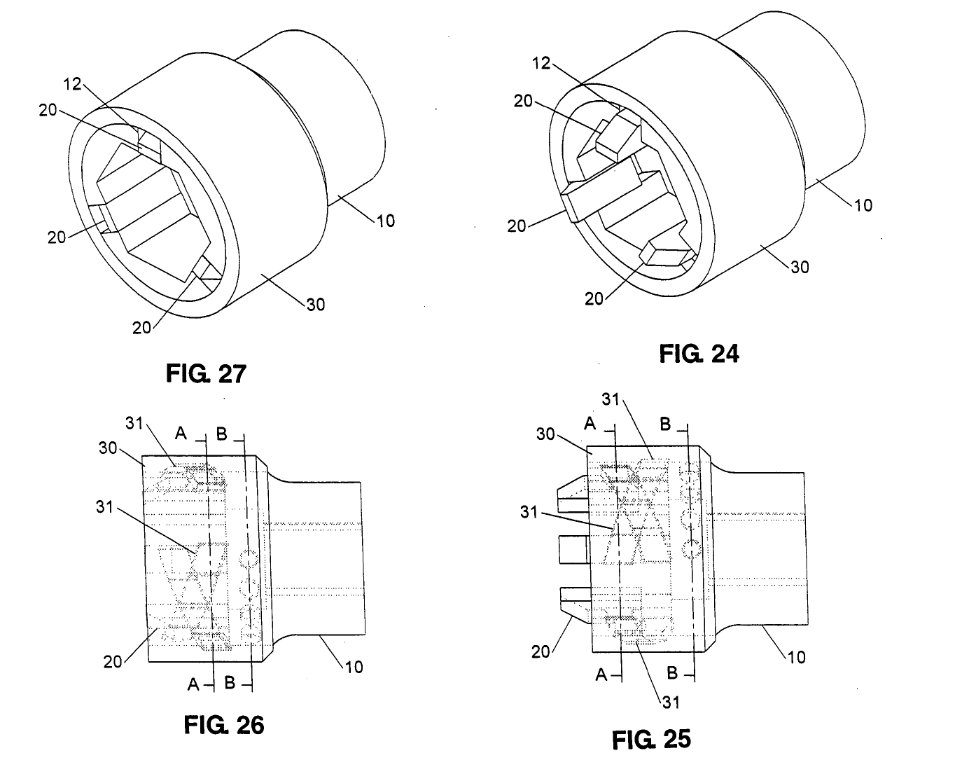

As shown on FIGS. 22 to 27, in the tenth embodiment of this invention, the push front 31 is extending spirally, the primary side of the push front 31 is close to the proximal end of the sleeve 30 and the secondary side is close to the distal end of the sleeve 30. The push front 31 is formed by a groove on the inner wall of the sleeve 30, the primary end of the moving part 20 stays inside the groove and contacts with the push front 31.

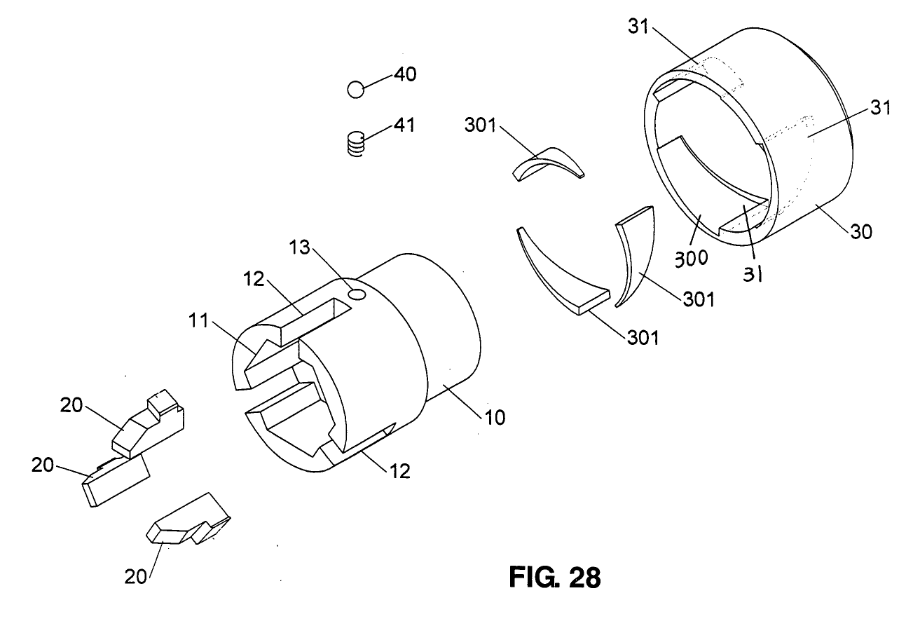

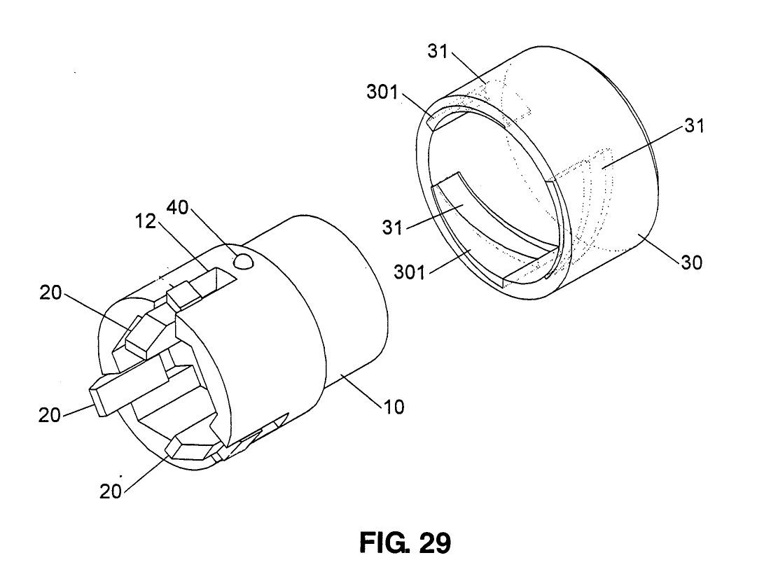

As shown on FIGS. 28 and 29, in the eleventh embodiment of this invention, the push front 31 is formed by a groove on the inner wall of the sleeve 30, one side of the groove is extending spirally toward the proximal end of the sleeve 30 and an opening 300 is formed. A plate 301 is implemented on the opening 300; the push front 31 is enclosed.

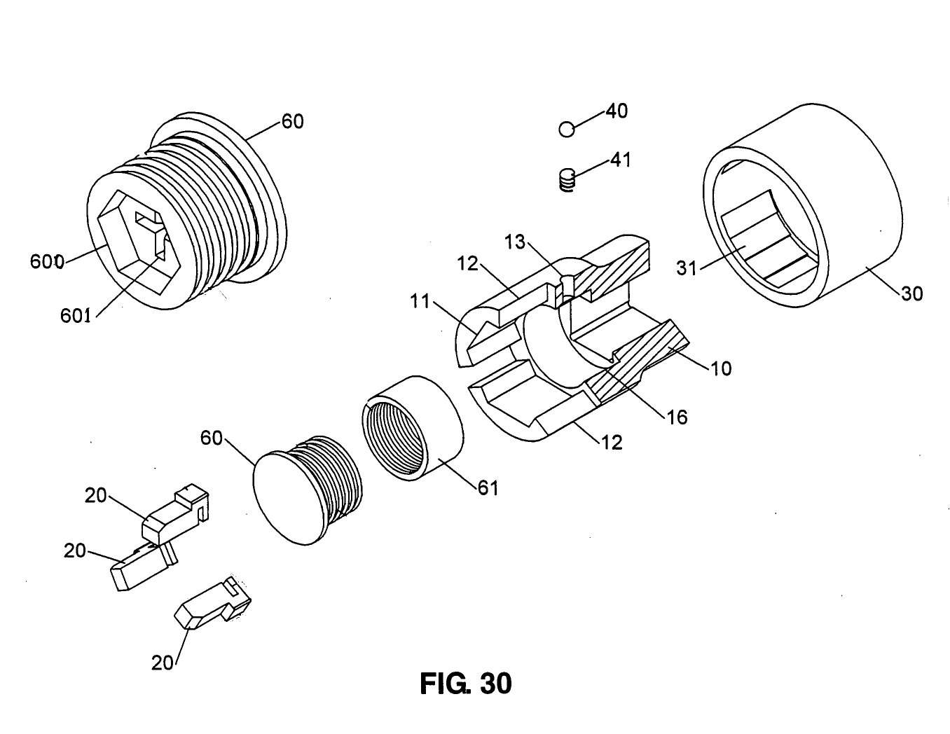

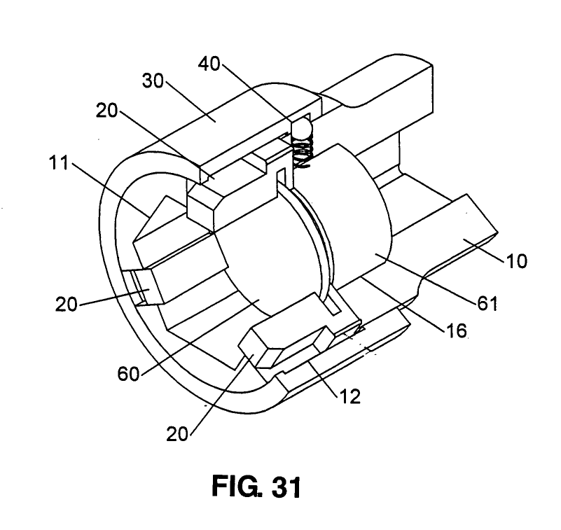

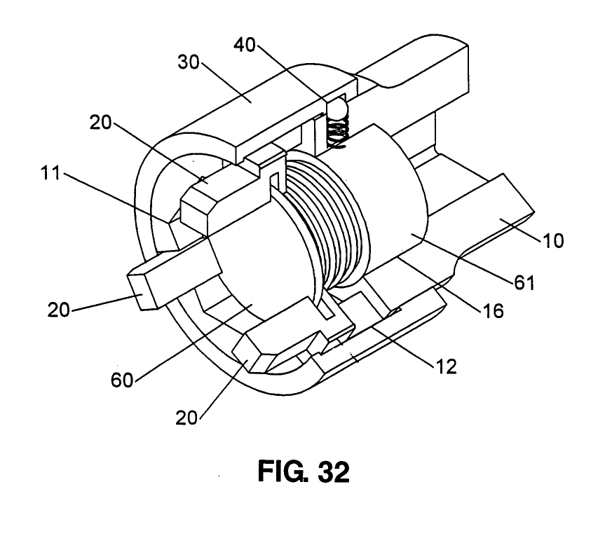

As shown on FIGS. 30 to 32, in the twelfth embodiment of this invention, a displacement adjusting mechanism is implemented in connection with the moving parts 20. The displacement adjusting mechanism comprises a rotator base 61 and a moving base 60 which are threaded with each other, the moving parts 20 is in connection with the moving base, the moving base 60 can be rotated relatively to the rotator base 61, and the position of the moving base 60 can be adjusted linearly in longitudinal directions of the main body 10, then the moving parts 20 can be moved by the moving base 60 in longitudinal directions of the main body 10. In one end of the moving base 60, a hexagonal cavity pit 600 or a cross screw slot 601 is implemented for using a spanner and a screwdriver to turn the moving base 60.

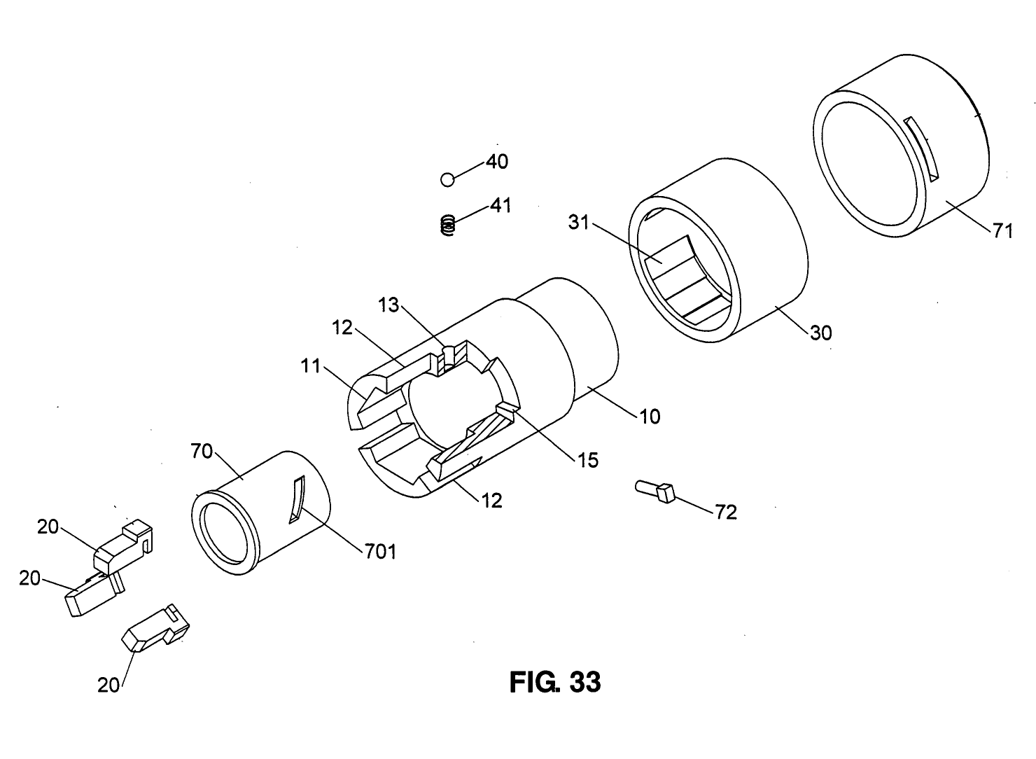

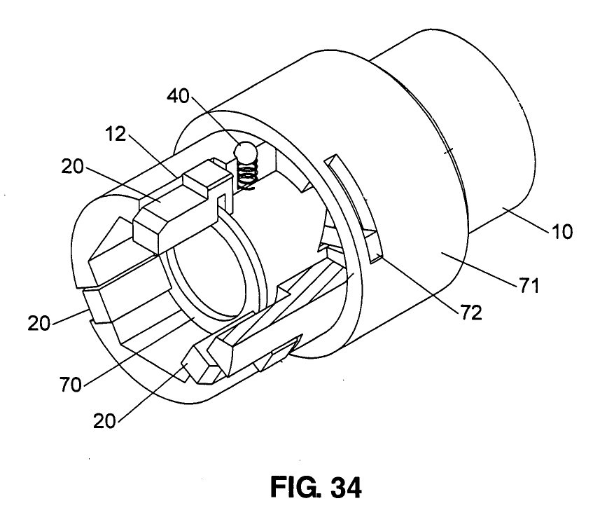

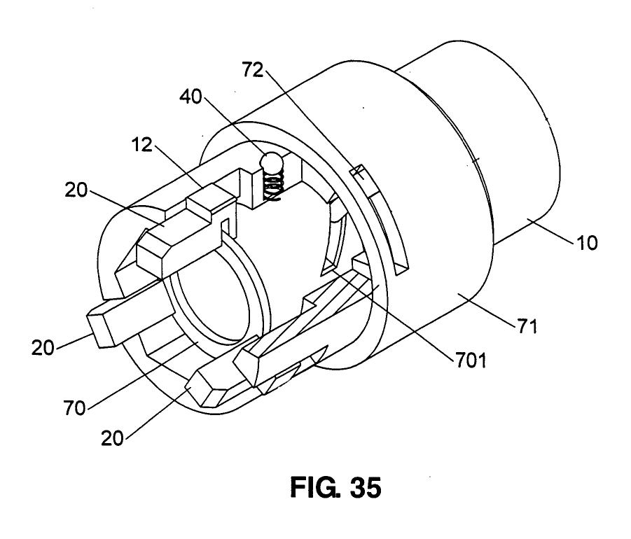

As shown on FIGS. 33 to 35, in the thirteenth embodiment of this invention, a displacement adjusting mechanism is implemented in connection with the moving part 20. The displacement adjusting mechanism comprises a rotator base 71 and a moving base 70, the moving base 70 can be rotated relatively to the rotator base 71, and the position of the moving base 70 can be adjusted linearly in longitudinal directions of the main body 10, then the moving part 20 can be moved in longitudinal directions of the main body 10. A guide slot 701 is extending spirally on the moving base 70, a guide rod 72 is installed on the rotator base 71 with its end penetrating through and staying in the guide slot 701 on the moving base 70. When the rotator base 71 is rotated relatively to the moving base 70, the rotator base 71 interlinks the guide rod 72 to move, and then the guide rod 72 pushes inside the guide slot 701 to move the moving base 70 linearly in longitudinal directions of the main body 10, then the moving part 20 is moved in longitudinal directions of the main body 10.

What is claimed is:

1. A socket for a wrench comprises:
a main body having a proximal end and a distal end; a central axis extending from the proximal end to the distal end, the main body having a recess on the proximal end with plurality punctures on the recessed periphery; each puncture having a moving part mounted therethrough, the moving part having a primary end and a secondary end; and
a sleeve having a inner wall and being in slide-fitting onto the outside of the main body, which has a second central axis parallel with the central axis of the main body; the inner wall of the sleeve providing plurality of push fronts thereon, each push front contacts with the primary end of the moving part, each push front surface rising gradually from one end to the other;
so that the gradual rising push fronts can push the moving parts toward the central axis when the sleeve is rotated with respect to the main body.

2. The socket as claimed in claim 1, wherein the distal end of the main body has a square cavity.

3. The socket as claimed in claim 1, wherein the outline of the recess is in the shape of polygon in the view of cross-section which is vertical with respect to the central axis.

4. The socket as claimed in claim 3, wherein outline of the recess is in the shape of hexagon in the view of cross-section which is vertical with respect to the central axis.

5. The socket as claimed in claim 1, wherein a ball groove is implemented on the periphery of the main body with a spring and a sphere installed, the inner wall of the sleeve provides plurality cavities thereon, plurality cavities are implemented to have the sphere to be positioned in to.

6. The socket as claimed in claim 1, wherein the push front on the inner wall of the sleeve is shaped as steps.

7. The socket as claimed in claim 1, wherein the number of the puncture on the main body is two, each puncture has a moving part mounted therethrough, and the number of the push front is two.

8. The socket as claimed in claim 1, wherein the number of the puncture on the main body is three, each puncture has a moving part mounted therethrough, and the number of the push front is three.

9. The socket as claimed in claim 1, wherein the recess is in a shape of polygon, and punctures are located on the corners of the polygonal recess; a V-shape groove is implemented on the secondary end of the moving part, which coincides with the angle of the polygon corners of the recess.

10. The socket as claimed in claim 1, wherein each secondary end of the moving part connects with a block.

11. The socket as claimed in claim 10, wherein the moving part and the block are screw fitted with each other.

12. The socket as claimed in claim 1, wherein the push front on the inner wall of the sleeve is divided to array of push fronts in different heights, the cavities on the inner wall of the sleeve are also implemented in array.

13. The socket as claimed in claim 1, wherein the push front on the inner wall of the sleeve is designed to rise gradually in the direction same as the central axis of the sleeve.

14. The socket as claimed in claim 1, wherein the number of the puncture on the main body is six, each puncture has a moving part mounted therethrough, and the number of the push front on the inner wall of the sleeve is six.

15. The socket as claimed in claim 1, wherein the push front on the inner wall of the sleeve rises gradually from one lateral side to the other lateral side.

16. The socket as claimed in claim 1, wherein the push front constructed by plurality round grooves in varieties of depth.

17. The socket as claimed in claim 1, wherein the push front is rising smoothly, instead of in shape of steps, from one side to the other.

18. The socket as claimed in claim 1, wherein the push front is formed by a groove on the inner wall of the sleeve.

19. The socket as claimed in claim 1, wherein the push front is extending spirally, the primary side of the push front is close to the proximal end of the sleeve and the secondary side is close to the distal end of the sleeve, the push front is formed by a groove on the inner wall of the sleeve, the primary end of the moving part stays inside the groove and contacts with the push front.

20. The socket as claimed in claim 1, wherein the push front is formed by a groove on the inner wall of the sleeve, one side of the groove is extending spirally toward the proximal end of the sleeve and an opening is formed, a plate is implemented on the opening such that the push front is enclosed.

21. The socket as claimed in claim 1, wherein a displacement adjusting mechanism is implemented in connection with the moving part, the displacement adjusting mechanism comprises a rotator base and a moving base, the moving part is in connection with the moving base, the moving base can be rotated relatively to the rotator base, and the position of the moving base can be adjusted linearly in longitudinal directions of the main body so as to actuate the moving part to move in longitudinal directions of the main body.

22. The socket as claimed in claim 21, wherein the rotator base and the moving base are threaded with each other, the moving base can be rotated relatively to the rotator base, and the position of the moving base can be adjusted linearly in longitudinal directions of the main body so as to actuate the moving part to move in longitudinal directions of the main body.

23. The socket as claimed in claim 22, wherein in one end of the moving base is a hexagonal cavity pit.

24. The socket as claimed in claim 22, wherein in one end of the moving base is a cross screw slot.

25. The socket as claimed in claim 21, wherein a guide slot is spirally extending on the moving base, a guide rod is installed on the rotator base with its end penetrating through and staying in the guide slot of the moving base, so that when the rotator base is rotated relatively to the moving base, the rotator base interlinks the guide rod to move, and then the guide rod pushes inside the guide slot to move the moving base linearly in longitudinal directions of the main body so as to actuate the moving part to move in longitudinal directions of the main body.
